(19) United States
(12) Patent Application Publication
(10) Pub. No.: US 2026/0331461 A1
(43) Pub. Date: Oct. 22, 2026

(54) NEGATIVE ELECTRODE AND SOLID-STATE LITHIUM SECONDARY BATTERY

(71) Applicant: HONDA MOTOR CO., LTD., Tokyo (JP)

(72) Inventors: Takafumi NAGAI, Saitama (JP); Wataru SHIMIZU, Saitama (JP); Narumi OHTA, Saitama (JP); Wataru HOSHIKAWA, Saitama (JP); Masataka FURUYAMA, Saitama (JP); Hiroshi SAKAI, Saitama (JP); Shodai KATO, Saitama (JP); Takamitsu ONUMA, Saitama (JP)

(21) Appl. No.: 19/529,122

(22) Filed: Feb. 4, 2026

(30) Foreign Application Priority Data
Mar. 31, 2025 (JP) 2025-059475

(51) Int. Cl. H01M 4/133; H01M 4/36; H01M 4/587; H01M 4/62; H01M 10/0525; H01M 4/02

(52) U.S. Cl. CPC H01M 4/133; H01M 4/366; H01M 4/587; H01M 4/628; H01M 10/0525; H01M 2004/027

(57) ABSTRACT

Provided is a negative electrode for a solid-state lithium secondary battery. The negative electrode includes a negative electrode mixture layer containing a negative electrode active material and a first solid electrolyte. The negative electrode active material contains silicon and is covered with a covering layer. The covering layer contains a second solid electrolyte and a polymer.

### CROSS-REFERENCE TO THE RELATED APPLCATION(S)

This application is based on and claims the benefit of priority from Japanese Patent Application No. 2025-059475, filed on 31 March 2025, the content of which is incorporated herein by reference.

### BACKGROUND OF THE INVENTION

### Field of the Invention

The present invention relates to a negative electrode for a solid-state lithium secondary battery and a solid-state lithium secondary battery.

### Related Art

Research and development on lithium metal secondary batteries that contribute to increase in energy efficiency has been carried out in recent years so that more people can access handy, reliable, sustainable, and advanced energy.

Japanese Unexamined Patent Application, Publication No. 2021-506090 describes a negative electrode for a lithium metal battery including: a lithium metal negative electrode; and a coating layer that is disposed on the lithium metal negative electrode and that contains a carbon-based material and a polymer binder. Here, the carbon-based material is spherical graphene balls containing graphene and a silicon-based material. The silicon-based material is SiOx (1 < x < 3).

Patent Document 1: Japanese Unexamined Patent Application, Publication No. 2021-506090

### SUMMARY OF THE INVENTION

However, lithium silicide (LiₓSi_{y}) is generated during charge of the lithium metal battery to cause the coating layer to expand, and the coating layer contracts during discharge of the lithium metal battery. Accordingly, when the negative electrode for a lithium metal battery described in Japanese Unexamined Patent Application, Publication No. 2021-506090 is applied for a solid battery and a restraint pressure is lowered, discharge capacity may decrease with charge and discharge.

An object of the present disclosure is to provide a negative electrode that is able to inhibit the decrease in discharge capacity with charge and discharge even when the restraint pressure of the solid-state lithium secondary battery is lowered.
(1) A negative electrode for a solid-state lithium secondary battery is provided which includes a negative electrode mixture layer containing a negative electrode active material and a first solid electrolyte, wherein the negative electrode active material contains silicon and is covered with a covering layer, and the covering layer contains a second solid electrolyte and a polymer.
(2) In the negative electrode as described in (1) above, the covering layer further contains a conductive auxiliary agent.
(3) In the negative electrode as described in (1) above, in the covering layer, a first layer containing the second solid electrolyte and a second layer containing the polymer are sequentially stacked.
(4) In the negative electrode as described in (3) above, the second layer further contains a conductive auxiliary agent.
(5) In the negative electrode as described in any one of (1) to (4) above, a mass ratio between the negative electrode active material and the covering layer is 95:5 or more and 80:20 or less.
(6) In the negative electrode as described in (5) above, the mass ratio between the negative electrode active material and the covering layer is 95:5 or more and 90:10 or less.
(7) In the negative electrode as described in any one of (1) to (4) above, a volume ratio between the negative electrode active material and the covering layer is 73:27 or more and 69:31 or less.
(8) In the negative electrode as described in (7) above, the volume ratio between the negative electrode active material and the covering layer is 73:27 or more and 71:29 or less.
(9) In the negative electrode as described in any one of (1) to (8) above, the negative electrode active material is a silicon-carbon composite material.
(10) In the negative electrode as described in (9) above, the negative electrode active material is a silicon-graphene composite material.
(11) A solid-state lithium secondary battery includes the negative electrode as described in any one of (1) to (10) above.

According to an embodiment of the present invention, it is possible to provide the negative electrode that is able to inhibit the decrease in discharge capacity with charge and discharge even when the restraint pressure of the solid-state lithium secondary battery is lowered.

### BRIEF DESCRIPTION OF THE DRAWINGS

FIG. 1 is a sectional view illustrating a part of structure of a negative electrode mixture layer according to one embodiment of the present invention;

FIG. 2 is a sectional view illustrating a part of structure of a negative electrode mixture layer according to another embodiment of the present invention;

FIG. 3 is a sectional view illustrating a part of structure of a negative electrode mixture layer according to a comparative embodiment of the present invention;

FIG. 4 is a graph showing discharge capacities at the first charge and discharge of half-cells of Example 1 and Comparative Examples 1 and 2; and

FIG. 5 is a graph showing discharge capacities at the third charge and discharge of the half-cells of Example 1 and Comparative Examples 1 and 2.

### DETAILED DESCRIPTION OF THE INVENTION

Hereinafter, embodiments of the present invention will be described with reference to the drawings.

### Negative Electrode

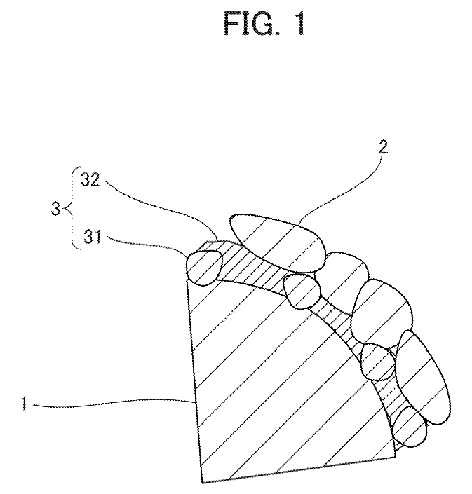

A negative electrode of the present embodiment is used for a solid-state lithium secondary battery, and has a negative electrode mixture layer containing a negative electrode active material 1 and a first solid electrolyte 2 (see FIG. 1). The negative electrode active material 1 contains silicon and is covered with a covering layer 3. The covering layer 3 contains a second solid electrolyte 31 and a polymer 32. Accordingly, the negative electrode of the present embodiment inhibits the decrease in discharge capacity with charge and discharge even when the restraint pressure of the solid-state lithium secondary battery is lowered. This is considered to be because peeling hardly occurs on an interface between the covering layer 3 and the first solid electrolyte 2 even when the negative electrode active material 1 expands during charge and the negative electrode active material 1 contracts during discharge. Here, the covering layer 3 may further contain a conductive auxiliary agent.

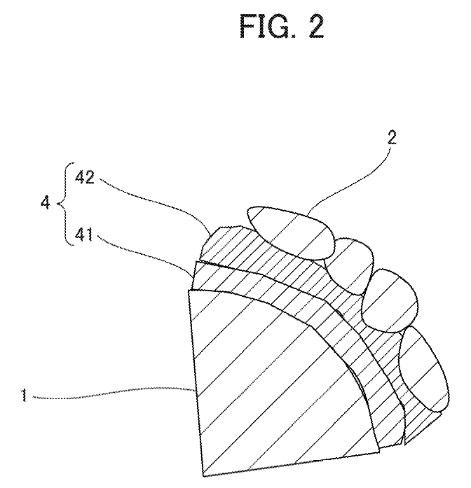

Note that the negative electrode active material 1 may be covered with a covering layer 4 in which a first layer 41 containing the second solid electrolyte and a second layer 42 containing the polymer are sequentially stacked, instead of the covering layer 3 (see FIG. 2). Here, the second layer 42 may contain a conductive auxiliary agent. Similarly, the second layer 42 may further contain a second solid electrolyte and a conductive auxiliary agent. In this case, the second solid electrolyte contained in the second layer 42 may be the same as or different from the second solid electrolyte contained in the first layer 41.

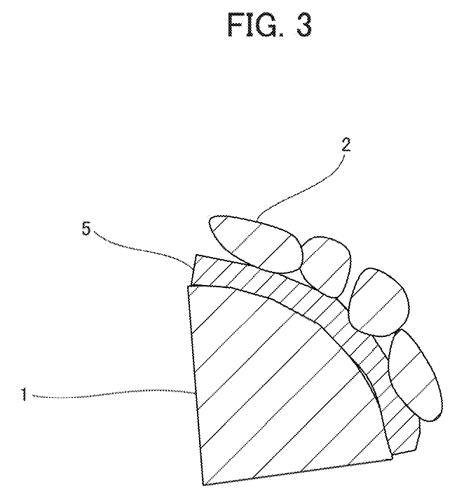

Meanwhile, if the negative electrode active material 1 is covered with a covering layer 5 containing the second solid electrolyte and the conductive auxiliary agent and containing no polymer (see FIG. 3), instead of the covering layer 3, the discharge capacity decreases with charge and discharge when the restraint pressure of the solid-state lithium secondary battery is lowered. This is considered to be because peeling easily occurs on an interface between the covering layer 5 and the first solid electrolyte 2 when the negative electrode active material 1 expands during charge and the negative electrode active material 1 contracts during discharge.

The negative electrode active material 1 is not particularly limited as long as it contains silicon and it can occlude and release lithium ions, and examples thereof include silicon and a silicon-carbon composite material. Among these, a silicon-graphene composite material is preferable in terms of discharge capacity of the solid-state lithium secondary battery.

A content of the negative electrode active material 1 in the negative electrode mixture layer is not particularly limited and is 50 mass% or more and 80 mass% or less, for example.

The first solid electrolyte is not particularly limited as long as it is a material that can conduct lithium ions, and examples thereof include an oxide-type electrolyte and a sulfide-type electrolyte. Among these, the sulfide-type electrolyte is preferable in terms of lithium-ion conductivity.

A content of the first solid electrolyte in the negative electrode mixture layer is not particularly limited and is 20 mass% or more and 50 mass% or less, for example.

A mass ratio between the negative electrode active material 1 and the covering layer 3 or the covering layer 4 is preferably 95:5 or more and 80:20 or less, and further preferably 95:5 or more and 90:10 or less. When the mass ratio between the negative electrode active material 1 and the covering layer 3 or the covering layer 4 is 95:5 or more, the decrease in discharge capacity with charge and discharge is inhibited even when the restraint pressure of the solid-state lithium secondary battery is lowered. When the mass ratio is 80:20 or less, the discharge capacity of the solid-state lithium secondary battery becomes high.

A volume ratio between the negative electrode active material 1 and the covering layer 3 or the covering layer 4 is preferably 73:27 or more and 69:31 or less, and further preferably 73:27 or more and 71:29 or less. When the volume ratio between the negative electrode active material 1 and the covering layer 3 or the covering layer 4 is 73:27 or more, the decrease in discharge capacity with charge and discharge is inhibited even when the restraint pressure of the battery is lowered. When the volume ratio is 69:31 or less, the discharge capacity of the solid-state lithium secondary battery becomes high.

The second solid electrolyte is not particularly limited as long as it is a material that can conduct lithium ions, and examples thereof include an oxide-type electrolyte and a sulfide-type electrolyte. Among these, the sulfide-type electrolyte is preferable in terms of lithium-ion conductivity.

Note that the second solid electrolyte may be the same as or different from the first solid electrolyte.

An average particle diameter of the second solid electrolyte is preferably 50nm or less, and further preferably 20nm or less. When the average particle diameter of the second solid electrolyte is 50nm or less, discharge capacity of the solid-state lithium secondary battery becomes high and resistance of the negative electrode of the present embodiment becomes low. Note that the average particle diameter of the second solid electrolyte is, for example, 5nm or more.

If the average particle diameter of the second solid electrolyte is more than 50nm, the negative electrode active material 1 may be covered with the second solid electrolyte to cut off an electron path necessary for the reaction. Thus, as described later, preferable is: the covering layer 3 containing the second solid electrolyte, the polymer, and the conductive auxiliary agent; or the second layer 42 containing the polymer and the conductive auxiliary agent.

A content of the second solid electrolyte in the covering layer 3 or the covering layer 4 is preferably 10 mass% or more and 50 mass% or less, and further preferably 20 mass% or more and 30 mass% or less. When the content of the second solid electrolyte in the covering layer 3 or the covering layer 4 is 20 mass% or more and 30 mass% or less, the decrease in discharge capacity with charge and discharge is inhibited even when the restraint pressure of the solid-state lithium secondary battery is lowered.

The polymer is not particularly limited as long as it has lithium-ion conductivity, and examples thereof include polyethylene oxide (PEO), polypropylene oxide (PPO), polyacrylonitrile (PAN), polymethyl methacrylate (PMMA), polyvinylidene fluoride (PVdF), polyvinyl chloride, polydimethylsiloxane, and vinylidene fluoride-hexafluoropropylene copolymer. Among these, polyethylene oxide (PEO) is preferable in terms of lithium-ion conductivity. Here, the polymer preferably has high durability such as no occurrence of side reactions with the sulfide-type electrolyte.

A lithium-ion conductance of the polymer is not particularly limited, and is 0.01 mS/cm or more and 1 mS/cm or less, for example.

A content of the polymer in the covering layer 3 or the covering layer 4 is preferably 1 mass% or more and 20 mass% or less, and further preferably 5 mass% or more and 10 mass% or less. When the content of the polymer in the covering layer 3 or the covering layer 4 is 5 mass% or more and 10 mass% or less, the decrease in discharge capacity with charge and discharge is inhibited even when the restraint pressure of the solid-state lithium secondary battery is lowered.

The covering layer 3 or the second layer 42 may further contain a conductive auxiliary agent. This lowers resistance of the negative electrode of the present embodiment.

The conductive auxiliary agent is not particularly limited as long as it has electron conductivity, and examples thereof include carbon black.

A content of the conductive auxiliary agent in the covering layer 3 or the covering layer 4 is not particularly limited, and is 1 mass% or more and 5 mass% or less, for example.

A method for covering the negative electrode active material 1 with the covering layer 3 is not particularly limited, and examples thereof include a method of spraying and drying a slurry containing the negative electrode active material 1, the second solid electrolyte 31, and the polymer 32. A method for covering the negative electrode active material 1 with the covering layer 4 is not particularly limited, and examples thereof include a method of spraying and drying a slurry containing the negative electrode active material 1 and the second solid electrolyte to form the first layer 41, and then spraying and drying a slurry containing the negative electrode active material 1 with the formed first layer 41 and the polymer 32 to form the second layer 42.

The negative electrode mixture layer may further contain a binder, a conductive auxiliary agent, etc. The binder is not particularly limited as long as it has a binding property, and examples thereof include polyvinylidene fluoride. The conductive auxiliary agent is not particularly limited as long as it has electron conductivity, and examples thereof include carbon black.

In the negative electrode of the present embodiment, the negative electrode mixture layer is formed on a negative electrode current collector, for example. The negative electrode current collector is not particularly limited, and examples thereof include copper foil.

A method for forming the negative electrode mixture layer is not particularly limited, and examples thereof include a method of applying a coating liquid containing the negative electrode active material 1 and the first solid electrolyte 2 on the negative electrode current collector.

### Solid-State Lithium Secondary Battery

A solid-state lithium secondary battery of the present embodiment has the negative electrode of the present embodiment. Examples of the solid-state lithium secondary battery include a semi-solid-state lithium secondary battery and an all-solid-state lithium secondary battery. Hereinafter, the all-solid-state lithium secondary battery will be described.

The all-solid-state lithium secondary battery has the negative electrode of the present embodiment, a positive electrode, and a solid electrolyte layer. Here, in the positive electrode, a positive electrode mixture layer is formed on a positive electrode current collector.

The positive electrode current collector is not particularly limited, and examples thereof include aluminum foil.

The positive electrode mixture layer contains a positive electrode active material, and may further contain a solid electrolyte, a conductive auxiliary agent, a binder, etc. The positive electrode active material is not particularly limited as long as it can occlude and release lithium ions, and examples thereof include a lithium-nickel-cobalt-manganese composite oxide.

In the solid electrolyte layer, a nonwoven fabric is impregnated with a solid electrolyte, for example. The solid electrolyte is not particularly limited as long as it is a material that can conduct lithium ions, and examples thereof include an oxide-type electrolyte and a sulfide-type electrolyte.

Embodiments of the present invention have been described above, but the present invention is not limited to the above embodiments, and the above embodiments may be appropriately modified within a range of the spirit of the present invention.

### EXAMPLES

Hereinafter, Example of the present invention will be described, but the present invention is not limited to Example. Note that "part(s)" means "part(s) by mass".

### Example 1

A sulfide-type electrolyte (a commercial product) having an average particle diameter of 700nm was crushed by using a jet-mill apparatus to obtain a sulfide-type electrolyte having an average particle diameter of 200nm. Note that the average particle diameter of the sulfide-type electrolyte was measured by using a scanning electron microscope.

Polyethylene oxide (a commercial product) having a lithium-ion conductance of 1.4×10⁻⁴ mS/cm, the sulfide-type electrolyte having an average particle diameter of 200nm, and acetylene black (a commercial product) were dissolved or dispersed in isobutyronitrile so that the mass ratio was 75:21:4 to obtain a slurry. Then, the slurry was dropped into a silicon-graphene composite material (a commercial product) as a negative electrode active material, and then the mixture was kneaded by using a mortar to cover the negative electrode active material with a covering layer. In this time, a mass ratio and a volume ratio between the negative electrode active material and the covering layer were 92:8 and 72:28, respectively.

By using a kneader, 70 parts of the negative electrode active material covered with the covering layer, 27 parts of the sulfide-type electrolyte having an average particle diameter of 200nm, 1 part of acetylene black (a commercial product) as a conductive auxiliary agent, and 2 parts of polyvinylidene fluoride (a commercial product) as a binder were dissolved or dispersed in butyl butyrate to obtain a coating liquid for a negative electrode mixture layer.

The coating liquid for a negative electrode mixture layer was applied on copper foil as a negative electrode current collector for forming a negative electrode mixture layer to obtain a negative electrode.

### Comparative Example 1

A negative electrode was obtained in the same manner as in Example 1 except that the negative electrode active material was not covered with the covering layer.

### Comparative Example 2

A negative electrode was obtained in the same manner as in Comparative Example 1 except that, in the production of the coating liquid for a negative electrode mixture layer, a mixture of polyethylene oxide (PEO) having a lithium-ion conductance of 1.4×10⁻⁴ mS/cm and the sulfide-type electrolyte having an average particle diameter of 200nm (mass ratio: 78:22) was used instead of the sulfide-type electrolyte having an average particle diameter of 200nm.

### Manufacturing of Half-Cell

The sulfide-type solid electrolyte was fed into a cylindrical ZrO₂ tube, then the tube was sandwiched with a tool made of SUS for pressing to obtain a solid electrolyte pellet. Then, the solid electrolyte pellet and the negative electrode were stacked, and then a forming pressure was applied to form a solid electrolyte layer. Then, lithium foil was stacked on the opposite side to the negative electrode of the solid electrolyte layer, and then the stacked product was restrained at a restraint pressure of 3 MPa to obtain a half-cell.

### Discharge Capacity of Half-Cell

The half-cell was charged at a constant current of 0.1 C until a rated capacity, left to stand at a voltage at the rated capacity until a residual current was 0.01 C or less, then the half-cell was discharged at a constant current of 0.1 C until 1.5 V, and left to stand for five minutes. This procedure was repeated three times to charge and discharge the half-cell, and discharge capacities at the first and the third charge and discharge were measured. Here, the discharge capacity means a discharge capacity per gram of the negative electrode.

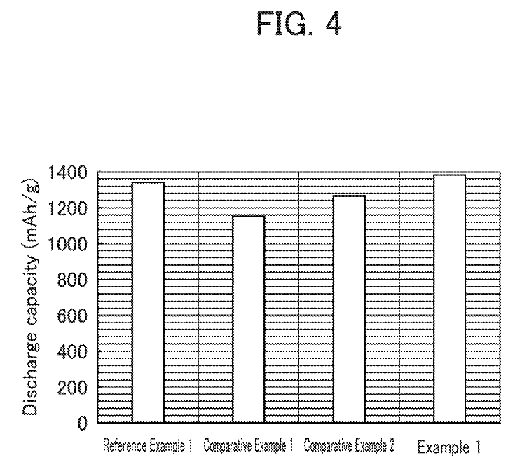

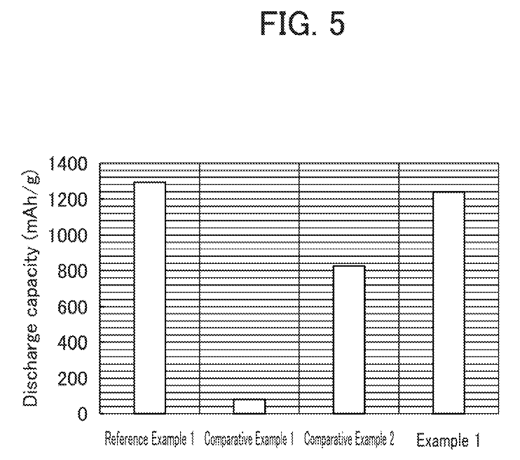

FIG. 4 shows the discharge capacities at the first charge and discharge of the half-cells of Example 1 and Comparative Examples 1 and 2. FIG. 5 shows the discharge capacities at the third charge and discharge of the half-cells of Example 1 and Comparative Examples 1 and 2. Note that Reference Example 1 was a case where the restraint pressure in the half-cell of Comparative Example 1 was set to 10 MPa.

From FIG. 4 and FIG. 5, it was understood that the half-cell of Example 1 inhibited the decrease in the discharge capacity with charge and discharge even when the restraint pressure was lowered. In contrast, the half-cells of Comparative Examples 1 and 2 decreased the discharge capacity with charge and discharge when the restraint pressure was lowered because the negative electrode active material was not covered with the covering layer.

### EXPLANATION OF REFERENCE NUMERALS

1 Negative electrode active material
2 First solid electrolyte
3, 5 Covering layer
31 Second solid electrolyte
32 Polymer
41 First layer
42 Second layer

What is claimed is:

1. A negative electrode for a solid-state lithium secondary battery, the negative electrode comprising
a negative electrode mixture layer containing a negative electrode active material and a first solid electrolyte,
wherein the negative electrode active material contains silicon and is covered with a covering layer, and
the covering layer contains a second solid electrolyte and a polymer.

2. The negative electrode according to claim 1, wherein the covering layer further contains a conductive auxiliary agent.

3. The negative electrode according to claim 1, wherein, in the covering layer, a first layer containing the second solid electrolyte and a second layer containing the polymer are sequentially stacked.

4. The negative electrode according to claim 3, wherein the second layer further contains a conductive auxiliary agent.

5. The negative electrode according to claim 1, wherein a mass ratio between the negative electrode active material and the covering layer is 95:5 or more and 80:20 or less.

6. The negative electrode according to claim 5, wherein the mass ratio between the negative electrode active material and the covering layer is 95:5 or more and 90:10 or less.

7. The negative electrode according to claim 1, wherein a volume ratio between the negative electrode active material and the covering layer is 73:27 or more and 69:31 or less.

8. The negative electrode according to claim 7, wherein the volume ratio between the negative electrode active material and the covering layer is 73:27 or more and 71:29 or less.

9. The negative electrode according to claim 1, wherein the negative electrode active material is a silicon-carbon composite material.

10. The negative electrode according to claim 9, wherein the negative electrode active material is a silicon-graphene composite material.

11. A solid-state lithium secondary battery comprising the negative electrode according to claim 1.
